(19) United States
(12) Patent Application Publication
(10) Pub. No.: US 2014/0285282 A1
(43) Pub. Date: Sep. 25, 2014

(54) POWER DIVIDING PHASE SHIFTER

(71) Applicants: Qi Zhu, Zhenjiang (CN); Hongbing Xing, Zhenjiang (CN)

(72) Inventors: Qi Zhu, Zhenjiang (CN); Hongbing Xing, Zhenjiang (CN)

(73) Assignee: ZHENIANG ZHONGAN COMMUNICATION SCIENCE & TECNOLOGY CO., LTD. CN), Zhenjiang (CN)

(21) Appl. No.: 13/984,017

(22) PCT Filed: Jan. 13, 2013
(86) PCT No.: PCT/CN12/70334

§ 371 Date: Aug. 6, 2013

(30) Foreign Application Priority Data
Jan. 4, 2012 (CN) 201210000627.8

(51) Int. Cl. H01P 1/18

(52) U.S. Cl. CPC H01P 1/184
USPC 333/101

(57) ABSTRACT

A power divider phase shifter is a structure of a hybrid ring formed of a power divider ring and two coupling rings. The input end of the power divider ring serves as the input of the power dividing phase shifter, while the output end of the power divider ring is connected with two parallel coupling rings, the output end of which each serves as the output of the power divider phase shifter.

### TECHNICAL FIELD

The invention belongs to the field of phased array feed network, in particular to an integrated design of feeding and phase shifting functions, specifically a power divider phase shifter.

### BACKGROUND OF THE INVENTION

A phased array design comprises a power divider network, a phase shifter and a control circuit design thereof. The integration complexity of those components and circuits, the system loss and the manufacturing cost are problems to be considered at the design stage.

An active phased array employs amplifiers with low efficiency and solid phase shifters with large insertion loss in a T/R (transmitting/receiving module) assembly, so that the application of the active phased array is limited in many fields. Therefore, reducing the number of phase shifters and further reducing the system loss attract much attention in the field of phased array.

In 2003, Abbas Abbaspour-Tamijani and Kamal Sarabandi published an essay “An Affordable Millimeter-wave Beam-steerable Antenna Using Interleaved Planar Subarrays”, IEEE Transaction on Antennas Propagation, vol. 51, no. 9, pp. 2193-2202, September 2003. In this essay, an antenna array is divided into combinations of a plurality of antenna sub-arrays. For each sub-array, only one phase shifter is adopted to control the feed phase. Each sub-array has same phases in the inner unit thereof. Actually, this is a technique of phase phantom. On this basis, the sub-arrays may be overlapped or crossed to reduce the number of phase shifters. However, this method may result in the grain drop of the antenna array and the increase of minor lobes.

In 2010, D. Ehyaie and A. Mortazawi issued an essay “A New Approach to Design Low Cost, Low Complexity Phased Arrays”, IEEE MTT-S International, pp. 1270-1273, 2010. In this essay, a new approach to design a phased array is proposed. The phased array network comprises a plurality of 3 dB directional couplers, amplifiers, power combiners and two phase shifters. The output of step phase and specific amplitude distribution may be realized by controlling the phase shifters and the amplifiers. Obviously, the substantial use of 3 dB directional couplers, amplifiers and power combiners also make the circuit structure have complicated circuit structure and low power efficiency.

In a passive phased array, each path of output generally needs an independent group of phase shifters to control the phase. When the phase shifters have many digits, the substantial use of phase shifters may result in complicated system circuit structure, large volume and high insertion loss. The integration design of power dividers and phase shifters to avoid the substantial use of phase shifters is an effective approach to reduce the complexity and loss of system. But so far, no reports on the integration design of power dividers and phase shifters have been found.

### SUMMARY OF THE INVENTION

The purpose of the invention is to provide a power divider phase shifter with compact structure and power division and phase shifting functions, in view of large volume, high loss, complicated circuit structure and other problems caused by the separated design of power dividers and phase shifters in the existing phased array feed network.

The invention adopts the following technical solutions.

A power divider phase shifter is provided, being a structure of a hybrid ring formed of a power divider ring and two coupling rings. The input end of the power divider ring serves as the input of the power dividing phase shifter, while the output end of the power divider ring is connected with two parallel coupling rings, the output end of which each serves as the output of the power divider phase shifter. The power divider ring is provided with a plurality of corresponding loading branches used for controlling a plurality of output states. A switch is arranged on each loading branch, respectively, by which the corresponding loading branches are controlled to realize power division and output of arithmetic phase signals in each state.

The power divider phase shifter of the invention is designed on a PCB. The PCB includes a first conductor layer, a dielectric layer and a second conductor layer in turn from top to bottom. The dielectric constant of the dielectric layer between the first conductor layer and the dielectric layer is greater than 1. The second conductor layer is ground. The first conducting layer is a micro-strip circuit, i.e., a power divider phase shifter.

The first conductor layer and the second conductor layer of the PCB in this invention are copper conductors, the thickness of which is 0.001 mm to 0.01 mm, and the thickness of the dielectric layer is 0.127 mm to 1 mm.

The size of an arithmetic phase corresponding to each state in this invention depends on the electrical length of a loading branch corresponding to this state.

In the invention, the number of the loading branches is equal to the number of states of the power divider phase shifter, and when there is an even number of states of the power divider phase shifter, multiple loading braches are mounted on two sides of the power divider ring symmetrically. (As there is an even number of digital phase shifting states, the number of states is designed to be an even. Mounting on two sides of the power divider ring symmetrically is according to the following design idea: due to structural symmetry, symmetrically mounting braches in same length may realize same amplitude and reverse output of arithmetic phase in fact, the shifting between two states of symmetrically loading branches in same length may realize the change of phase difference of adjacent output ports while keeping the amplitude unchanged.)

There are four states of the power divide phase shifter in the invention, and four loading braches are mounted on two sides of the power divider ring symmetrically. The loading braches on the same side of the power divider ring have different length, and the length difference between the two loading branches determines a variation of arithmetic phases output in the two corresponding states. The length of a short loading branch is 0.5 mm to 1.5 mm, and the length of a long loading branch is 3 mm to 4 mm. (As each state is corresponding to one loading branch to form an arithmetic phase distribution of a certain phase, if the arithmetic phase is supposed to be theta1, loading of another branch also forms an arithmetic phase distribution; and if the arithmetic phase is supposed to be theta2 with a different value from theta1, the length difference between the two braches determines a difference value of arithmetic phases of the two states, i.e., theta2-theta1.)

In the invention, when the length difference between two loading braches on the same side is 0 mm to 4 mm, the phase difference between adjacent output ports is 0° to 20°.

The line width of the loading braches in the invention is 0.2 mm to 0.6 mm, and the distance between any two loading braches on the same side is less than 2 mm.

The line width of both an input line and an output line of the power dividing phase shifter in the invention is 0.4 mm to 1.2 mm.

In this invention, the distance from each switch on each loading branch to the power divider ring is 1.4 mm to 1.8 mm.

The invention has the following advantages.

Based on the nonlinear dispersion characteristics of a transmission line loaded with branches, by controlling the loading branches by switches on a micro-strip structure with a power division function, the invention realizes power division and output of arithmetic phase signals. The size of the arithmetic phase depends on the electrical length of the loading branches. The power divider phase shifter is compact in structure and has power division and phase shifting functions.

### BRIEF DESCRIPTIONS OF THE DRAWINGS

FIG. 1 is a three-dimensional structure view of Embodiment 1 of a power divider phase shifter in the invention;

FIG. 2 is a side structure view of Embodiment 1 of a power divider phase shifter in the invention;

FIG. 3 is a top structure view of Embodiment 1 of a power divider phase shifter in the invention;

FIG. 4 is a schematic diagram of scattering parameters of Embodiment 1 of a power divider phase shifter in the invention in a first working state;

FIG. 5 is a schematic phase diagram of a scattering parameter S(2,1) of Embodiment 1 of a power divider phase shifter in the invention in a first working state;

FIG. 6 is a schematic diagram of scattering parameters of Embodiment 1 of a power divider phase shifter in the invention in a second working state;

FIG. 7 is a schematic phase diagram of a scattering parameter S(2,1) of Embodiment 1 of a power divider phase shifter in the invention in a second working state;

FIG. 8 is a schematic diagram of scattering parameters of Embodiment 1 of a power divider phase shifter in the invention in a third working state;

FIG. 9 is a schematic phase diagram of a scattering parameter S(2,1) of Embodiment 1 of a power divider phase shifter in the invention in a third working state;

FIG. 10 is a schematic diagram of scattering parameters of Embodiment 1 of a power divider phase shifter in the invention in a fourth working state; and,

FIG. 11 is a schematic phase diagram of a scattering parameter S(2,1) of Embodiment 1 of a power divider phase shifter in the invention in a fourth working state.

### DETAILED DESCRIPTIONS OF THE INVENTION

The invention will be further described as below in details by embodiments with reference to drawings.

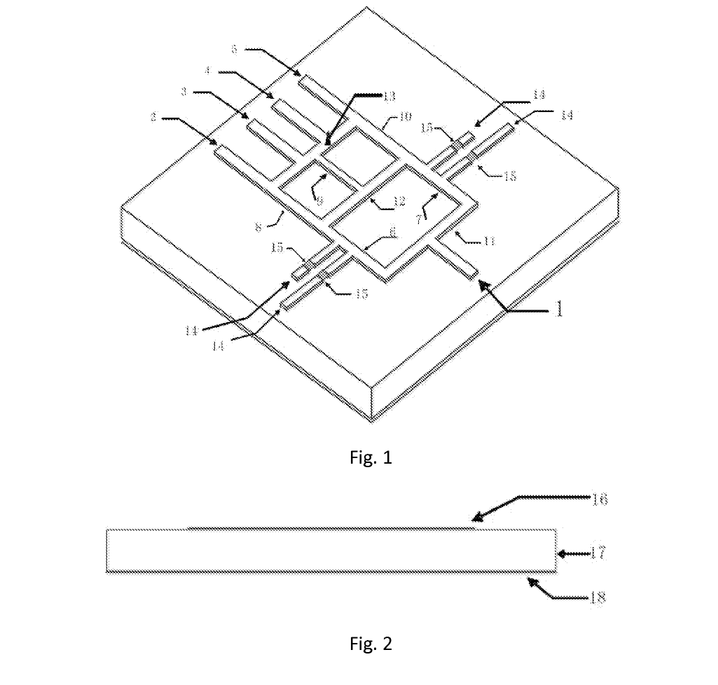

As shown in FIG. 1, a power divider phase shifter is provided, being a structure of a hybrid ring formed of a power divider ring and two coupling rings. The input end of the power divider ring serves as the input of the power dividing phase shifter, while the output end of the power divider ring is connected with two parallel coupling rings, the output end of which each serves as the output of the power divider phase shifter. The power divider ring is provided with a plurality of corresponding loading branches 14 used for controlling a plurality of output states. A switch 15 is arranged on each loading branch 14, respectively, by which the corresponding loading branches 14 are controlled to realize power division and output of arithmetic phase signals in each state.

As shown in FIG. 2, the power divider phase shifter of t his invention is designed in a PCB. The PCB includes a first conductor layer 16, a dielectric layer 17 and a second conductor layer 18 in turn from top to bottom, the dielectric constant of the dielectric layer 17 between the first conductor layer 16 and the dielectric layer 17 being greater than 1, the second conductor layer 18 being the ground, and the first conducting layer 16 being a micro-strip circuit, i.e., a power divider phase shifter. The first conductor layer 16 and the second conductor layer 18 of the PCB are copper conductors, the thickness of which is 0.001 mm to 0.01 mm, and the thickness of the dielectric layer 17 is 0.127 mm to 1 mm.

The size of an arithmetic phase corresponding to each state in this invention depends on the electrical length of a loading branch 14 corresponding to this state. The number of the loading branches 14 is equal to the number of states of the power divider phase shifter, and when there is an even number of states of the power divider phase shifter, multiple loading braches 14 are mounted on two sides of the power divider ring symmetrically. (As there is an even number of digital phase shifters, the number of states is designed to be an even. Mounting on two sides of the power divider ring symmetrically is according to the following design idea: due to structural symmetry, symmetrically mounting braches in same length may realize same amplitude and reverse output of arithmetic phase in fact, the shifting between two states of symmetrically loading branches in same length may realize the change of phase difference of adjacent output ports while keeping the amplitude unchanged.). When the length difference between two loading braches 14 on the same side is 0 mm to 4 mm, the phase difference between adjacent output ports is 0° to 20°. The line width of the loading braches 14 is 0.2 mm to 0.6 mm, and the distance between any two loading braches 14 on the same side is less than 2 mm.

The line width of both an input line 1 and an output line 2-5 of the power dividing phase shifter in the invention is 0.4 mm to 1.2 mm.

In this invention, the distance from each switch 15 on each loading branch 14 to the power divider ring is 1.4 mm to 1.8 mm. Embodiment 1

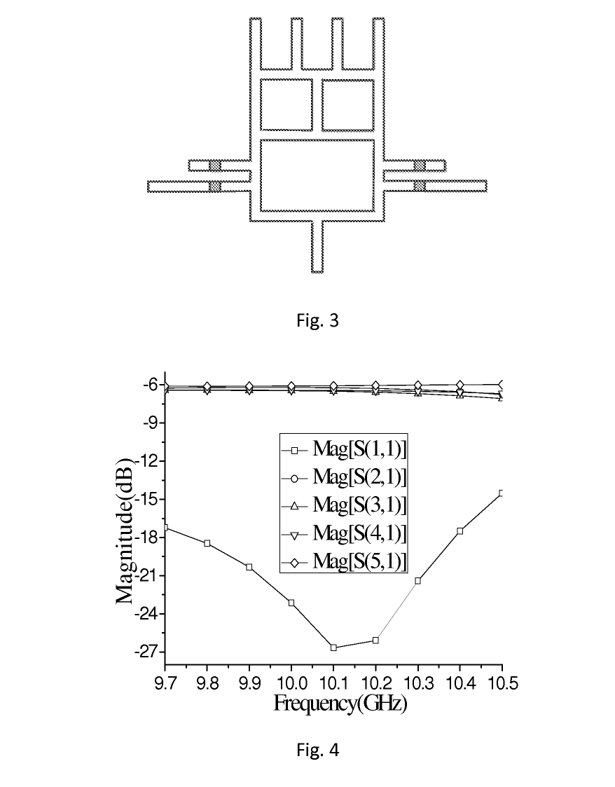

As shown in FIG. 1, FIG. 2 and FIG. 3, the left-hand micro-strip transmission line based phase shifter with is designed on a PCB. A Rogers RT/Duroid 5880 dielectric substrate is employed. The first layer and the third layer of the PCB are copper conductors, the thickness of which is 0.004 mm. Ground 1 of the left-hand micro-strip transmission line is formed by the metal on the third layer. The middle layer is a dielectric layer 2 with dielectric constant of 2.2 and thickness of 0.254 mm. 1 represents an input port. 2, 3, 4 and 5 represent output ports. The line width is 0.78 mm. Supposed that there are four states of the power divider phase shifter, four loading braches 14 are mounted on two sides of the power divider ring symmetrically. The loading braches on the same side of the power divider ring have different length, and the length difference between the both determines an output phase difference.

The line width of broadsides 6 and 7 of the power divider ring is 0.78 mm, and the length of long edges 11 and 12 of the power divider ring, i.e., distance between broadsides 1 and 7, is 6.22 mm. The line width of broadsides 8, 9 and 10 of the coupling rings is 0.6 mm; and the length of long edges of the coupling rings, i.e., distance between broadsides 8 and 9 or broadsides 9 and 10, is 3.22 mm.

The line width of the long edge 11 of the power divider ring is 1.00mm, the line width of the long edge 12 of the power divider ring is 1.10 mm, and the line width of long edges 13 of two coupling rings is 0.78 mm. The distance between the long edges 11 and 12 of the power divider ring, i.e., length of broadsides 6 and 7 of the power divider ring, is 5.4 mm. The length of broadsides 8, 9 and 10 of the coupling rings, i.e., distance between the long edges 12 and 13 of the coupling rings, is 3.1 mm.

The length of a short loading branch is 0.8 mm, and the length of a long loading branch is 3.5 mm. The loading braches are mounted on two sides of the power divider symmetrically. The distance from the rear end of the long loading branch to the power divider is 5.2 mm, while the distance from the rear end of the short loading branch to the power divider is 2.6 mm. The distance from each switch 15 to the power divider is 1.6 mm. The length of an output transmission line in the adjustment structure may make the first working state realize constant-amplitude and in-phase output, and other states realize constant-amplitude and arithmetic-phase output.

Table 1 shows definition of working states of Embodiment 1 of a power divider phase shifter in the invention.

TABLE 1

| | Amount of | | | | |
|---|---|---|---|---|---|
| State | phase shift | Switch 1 | Switch 2 | Switch 3 | Switch 4 |
| II | 0 | 1 | 0 | 0 | 0 |
| III | 11.25 | 0 | 1 | 0 | 0 |
| III I | 22.5 | 0 | 0 | 1 | 0 |
| IV | 33.75 | 0 | 0 | 0 | 1 |

(0 represents Off; and 1 represents On)

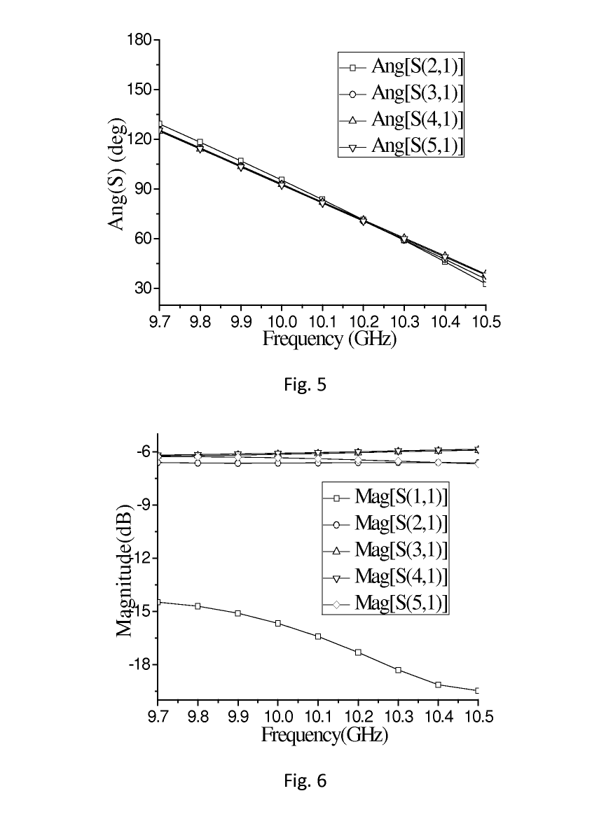

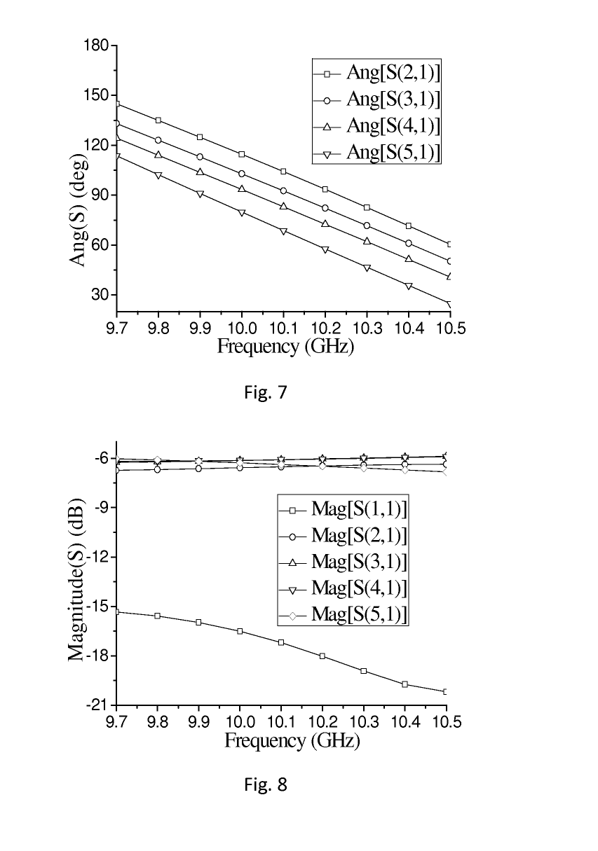

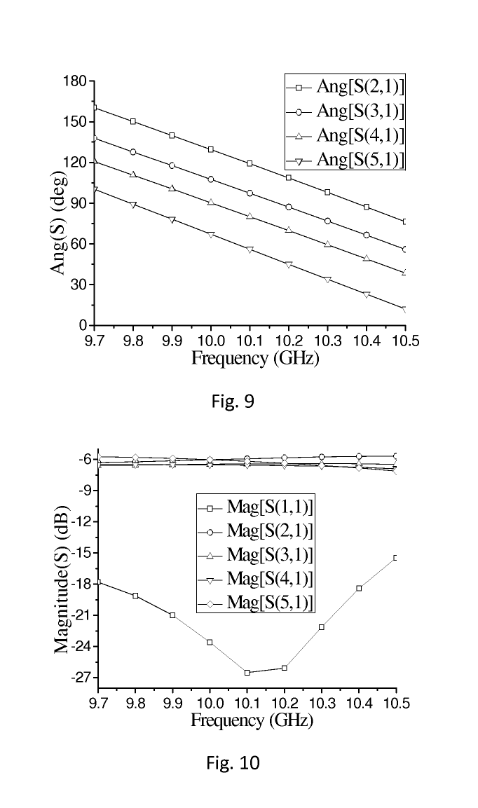

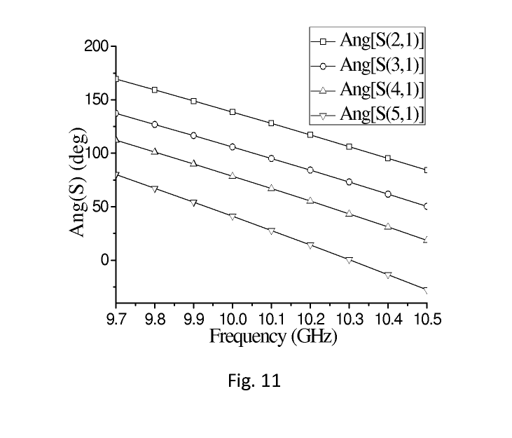

The specific embodiment may realize the following electrical properties: central frequency: 10 GHz; and working bandwidth: 9.7 GHz to 10.5 GHz. Table 1 shows four working states. FIG. 1 to FIG. 3 are three-dimensional view, side view and top view of the structure. FIG. 4 and FIG. 5 represent constant-amplitude and in-phase output realized in the first working state. FIG. 6 and FIG. 7 represent constant-amplitude and arithmetic-phase output (11.25°) realized in the second working state. FIG. 8 and FIG. 9 represent constant-amplitude and arithmetic-phase output (22.5°) realized in the second working state. FIG. 10 and FIG. 11 represent constant-amplitude and arithmetic-phase output) (33.5°) realized in the second working state.

Contents not involved in the invention are same as the prior art or may be realized by the prior art.

1. A power divider phase shifter, characterized in that the power divider phase shifter is a structure of a hybrid ring formed of a power divider ring and two coupling rings; the input end of the power divider ring serves as the input of the power divider phase shifter, while the output end of the power divider ring is connected with two parallel coupling rings, the output ends of which each serves as the output of the power divider phase shifter; the power divider ring is installed with a plurality of corresponding loading branches (14), used for controlling a plurality of output states; and a switch (15) is arranged on each loading branch (14), respectively, by which the corresponding loading branches (14) are controlled to realize power division and arithmetic phase signals in each state.

2. The power divider phase shifter according to claim 1, characterized in that the power dividing phase shifter is designed on a PCB board; and the PCB includes a first conductor layer (16), a dielectric layer (17) and a second conductor layer (18) in turn from top to bottom, the dielectric constant of the dielectric layer (17) between the first conductor layer (16) and the dielectric layer (17) being greater than 1, the second conductor layer (18) being ground, and the first conducting layer (16) being a micro-strip circuit, i.e., a power divider phase shifter.

3. The power divider phase shifter according to claim 2, characterized in that the first conductor layer (16) and the second conductor layer (18) of the PCB are copper conductors, the thickness of which is 0.001 mm to 0.01 mm, and the thickness of the dielectric layer (17) is 0.127 mm to 1 mm.

4. The power divider phase shifter according to claim 1, characterized in that the size of an arithmetic phase corresponding to each state depends on the electrical length of a loading branch (14) corresponding to this state.

5. The power divider phase shifter according to claim 1, characterized in that the number of the loading branches (14) is equal to the number of states of the power divider phase shifter, and when there is an even number of states of the power divider phase shifter, multiple loading braches (14) are mounted on two sides of the power divider ring symmetrically.

6. The power divider phase shifter according to claim 5, characterized in that there are four states of the power divider phase shifter, and four loading braches (14) are mounted on two sides of the power divider ring symmetrically, the loading braches on the same side of the power divider ring having different length, the length difference between the two loading branches determining a variation of arithmetic phases output in the two corresponding states, the length of a short loading branch being 0.5 mm to 1.5 mm, and the length of a long loading branch being 3 mm to 4 mm.

7. The power divider phase shifter according to claim 5, characterized in that when the length difference between two adjacent loading braches (14) on the same side is 0 mm to 4 mm, the variation of arithmetic phases from the adjacent output ports is 0° to 20°.

8. The power divider phase shifter according to claim 6, characterized in that when the length difference between two adjacent loading braches (14) on the same side is 0 mm to 4 mm, the variation of arithmetic phases from the adjacent output ports is 0° to 20°.

9. The power divider phase shifter according to claim 6, characterized in that the line width of all the loading braches (14) is 0.2 mm to 0.6 mm, and the distance between any two loading braches (14) on the same side is less than 2 mm.

10. The power divider phase shifter according to claim 1, characterized in that the line width of both an input line (1) and an output line (2-5) of the power dividing phase shifter is 0.4 mm to 1.2 mm.

11. The power divider phase shifter according to claim 1, characterized in that the distance from each switch (15) on each loading branch (14) to the power divider ring is 1.4 mm to 1.8 mm.
